(19) United States
(12) Patent Application Publication
(10) Pub. No.: US 2015/0185850 A1
(43) Pub. Date: Jul. 2, 2015

(54) INPUT DETECTION

(71) Applicants: Farzin Guilak, Beaverton, OR (US); Joel Morrissette, Beaverton, OR (US); Christopher J. Crase, Portland, OR (US); Soren C. Knudsen, Hillsboro, OR (US); Chukwuyem D. Emelue, Atlanta, GA (US); Danielle Galbraith, Portland, OR (US); Steven W. Asbjornsen, Tualatin, OR (US)

(72) Inventors: Farzin Guilak, Beaverton, OR (US); Joel Morrissette, Beaverton, OR (US); Christopher J. Crase, Portland, OR (US); Soren C. Knudsen, Hillsboro, OR (US); Chukwuyem D. Emelue, Atlanta, GA (US); Danielle Galbraith, Portland, OR (US); Steven W. Asbjornsen, Tualatin, OR (US)

(21) Appl. No.: 14/142,637

(22) Filed: Dec. 27, 2013

(51) Int. Cl. G06F 3/01

(52) U.S. Cl. CPC G06F 3/017

(57) ABSTRACT

A method and systems for detecting a gesture and intended input are described herein. In one example, a method includes detecting the gestures from an input device and detecting a set of measurements, wherein each measurement corresponds to a gesture. The method also includes detecting that the set of measurements and the gestures correspond to a stored pattern and determining an intended input from the gestures based on the stored pattern.

### BACKGROUND

1. Field

This disclosure relates generally to detecting input, and more specifically, but not exclusively, to detecting gestures.

2. Description

Many computing devices accept user input from a wide range of input devices. For example, many mobile devices accept user input from touch screens that display virtual keyboards. Additionally, many computing devices accept user input from physical keyboards. As users use the mobile devices in additional environments, the users may inadvertently enter erroneous input. For example, users may select keys along the edge of a keyboard while holding a mobile device.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can detect a gesture;

FIG. 2 is a process flow diagram of an example method for detecting the gesture;

FIG. 3 is a process flow diagram of an example method for storing patterns that can be used to detect a gesture;

FIG. 4 is an example chart of threshold values that correspond with input;

FIG. 5 is a block diagram depicting an example of a tangible, non-transitory computer-readable medium that can detect a gesture.

FIG. 6 is a block diagram of an example of a computing system that can detect a gesture from a gesture device;

FIG. 7A is a block diagram of an example of a gesture device;

FIG. 7B is a diagram illustrating an embodiment with multiple gesture devices;

FIG. 8 is a process flow diagram of an example method for detecting gestures from a gesture device;

FIG. 9 is a block diagram depicting an example of a tangible, non-transitory computer-readable medium that can detect gestures from a gesture device;

FIG. 10 is a block diagram of an example of a computing system that can detect a waveform;

FIG. 11 is a process flow diagram of an example method for detecting a waveform;

FIGS. 12A, 12B, and 12C are examples of waveforms that correspond to an input;

FIG. 13 is a block diagram depicting an example of a tangible, non-transitory computer-readable medium that can detect a waveform;

FIG. 14A is a block diagram of an example input device that can detect input and/or gestures; and

FIG. 14B is a block diagram of an example key from the input device that can detect input and/or gestures.

### DESCRIPTION OF THE EMBODIMENTS

According to embodiments of the subject matter discussed herein, a computing device can detect gestures. A gesture, as referred to herein, includes any suitable movement, action, and the like that corresponds to input for a computing device. For example, a gesture may include a keystroke on a keyboard, or a movement captured by sensors, among others. In some embodiments, a gesture may include erroneous input and intended input. Erroneous input, as referred to herein, includes any keystrokes, selections on touch screen devices, or any other input that was inadvertently entered by a user. For example, a user may hold a mobile device, such as a tablet, or a cell phone, among others, and the user may rest fingers along the edge of the mobile device. As a result, the user may inadvertently generate user input by selecting a key from a keyboard, among others. Intended input, as referred to herein, includes any keystrokes, selections on a touch screen device, or any other input that a user expects to be detected by a computing device.

In some examples, the computing device can detect the pressure and the velocity that corresponds with each selection of user input. For example, the computing device may detect that any suitable number of keys have been pressed on an input device. The computing device may also determine that the velocity of one of the key presses was higher than the velocity of the additional key presses. Therefore, the computing device may determine that the keys pressed with a level of pressure and a low level of velocity may be erroneous input.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

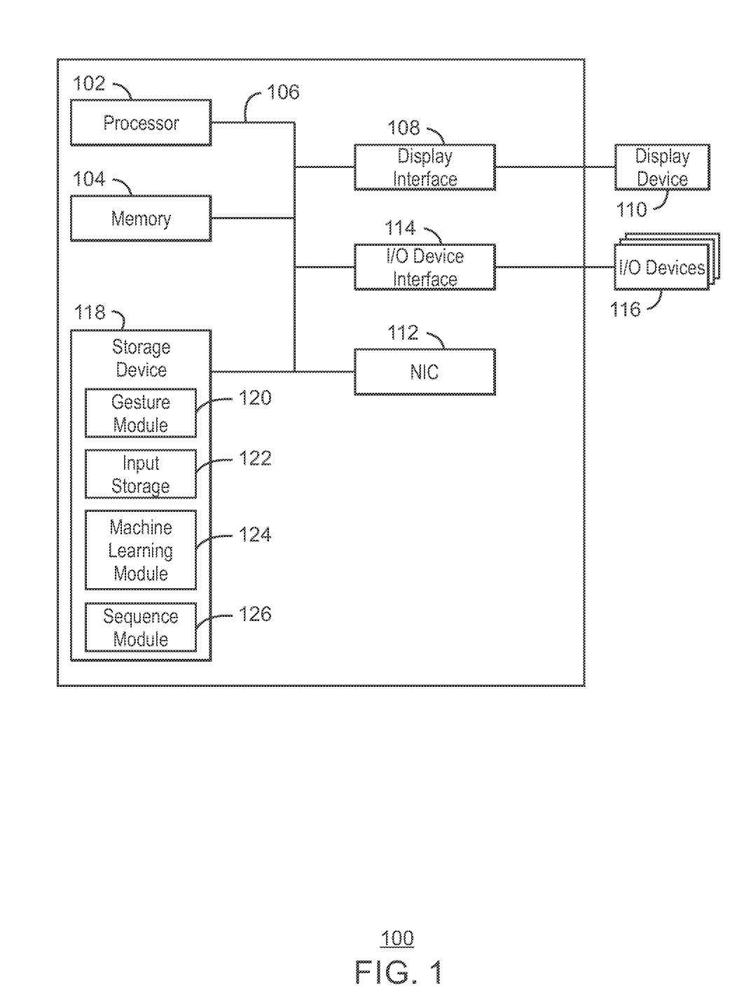

FIG. 1 is a block diagram of an example of a computing device that can detect a gesture. The computing device 100 may be, for example, a mobile phone, laptop computer, desktop computer, or tablet computer, among others. The computing device 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory, read only memory, flash memory, or any other suitable memory systems. The instructions that are executed by the processor 102 may be used to implement a method that can detect a gesture.

The processor 102 may also be linked through the system interconnect 106 (e.g., PCI®, PCI-Express®, HyperTransport®, NuBus, etc.) to a display interface 108 adapted to connect the computing device 100 to a display device 110. The display device 110 may include a display screen that is a built-in component of the computing device 100. The display device 110 may also include a computer monitor, television, or projector, among others, that is externally connected to the computing device 100. In addition, a network interface controller (also referred to herein as a NIC) 112 may be adapted to connect the computing device 100 through the system interconnect 106 to a network (not depicted). The network (not depicted) may be a cellular network, a radio network, a wide area network (WAN), a local area network (LAN), or the Internet, among others.

The processor 102 may be connected through a system interconnect 106 to an input/output (I/O) device interface 114 adapted to connect the computing device 100 to one or more I/O devices 116. The I/O devices 116 may include, for example, a keyboard and a pointing device, wherein the pointing device may include a touchpad or a touchscreen, among others. The I/O devices 116 may be built-in components of the computing device 100, or may be devices that are externally connected to the computing device 100.

The processor 102 may also be linked through the system interconnect 106 to a storage device 118 that can include a hard drive, an optical drive, a USB flash drive, an array of drives, or any combinations thereof. In some embodiments, the storage device 118 can include a gesture module 120 that can detect any suitable gesture from an input device 116. In some examples, the gesture may include a set of input that corresponds to any suitable number of keystrokes or selections of a touchscreen display device, among others. In some embodiments, the gesture module 120 can also detect a measurement for each detected gesture. A measurement, as referred to herein, includes the pressure and/or velocity that correspond to a gesture such as a keystroke or selection of a touchscreen device, among others. In some examples, the gesture module 120 may detect more than one measurement that corresponds to a set of input included in a detected gesture. The gesture module 120 may use a measurement for each detected gesture to determine if a user entered an erroneous input. For example, a user may have rested a hand on a keyboard while typing, which could have resulted in a gesture module 120 detecting multiple key selections despite a user intending to select a single key.

In some embodiments, the gesture module 120 can determine if a gesture includes erroneous input by comparing the detected gesture and the measurements for the detected gesture with patterns stored in input storage 122. A pattern, as referred to herein, can include any previously detected gesture, any number of measurements associated with the previously detected gesture, and an indication of erroneous input and/or intended input included in the previously detected gesture. As discussed above, erroneous input can include any keystrokes, selections on touch screen devices, or any other input that was inadvertently entered by a user. For example, a user may hold a mobile device, such as a tablet, or a cell phone, among others, and the user may rest fingers along the edge of the mobile device. As a result, the user may inadvertently generate user input by selecting a key from a keyboard, among others. Intended input can include any keystrokes, selections on a touch screen device, or any other input that a user expects to be detected by a computing device. In some examples, the patterns stored in input storage 122 may indicate that the selection of a set of keys on a keyboard may include a subset of erroneously selected keys. In some examples, the subset of erroneously selected keys can result from a user inadvertently selecting keys while entering input on an I/O device 116. The gesture module 120 can compare detected gestures to the previously stored patterns of input to determine if the detected gesture includes erroneous input.

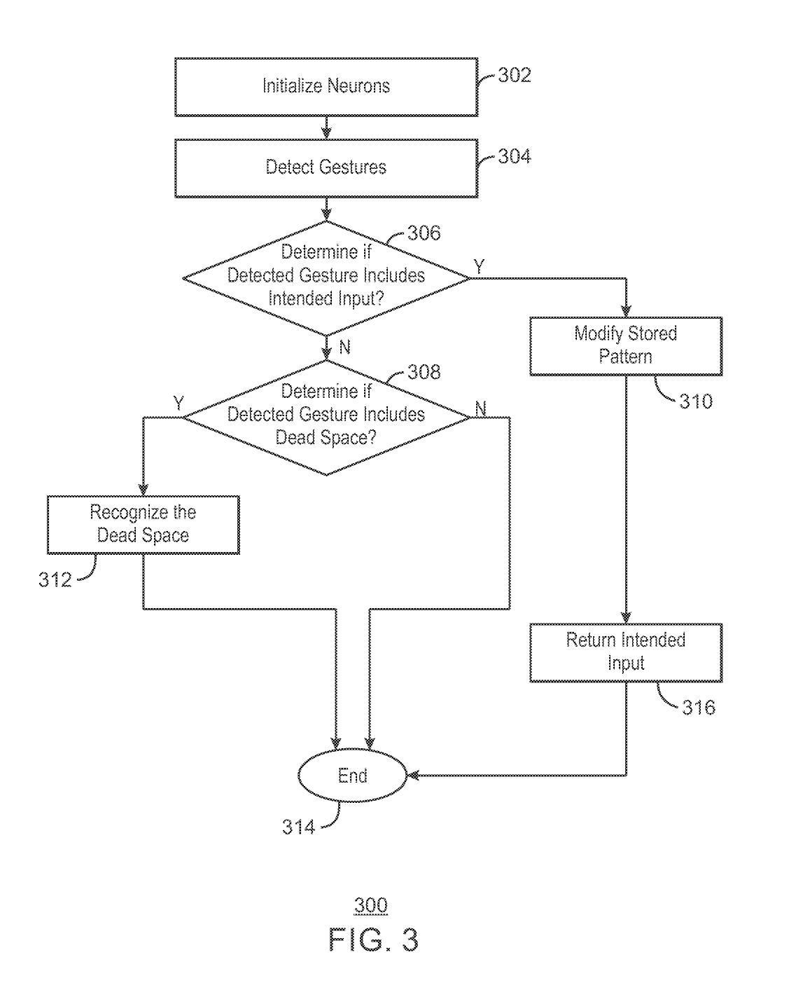

In some embodiments, the gesture module 120 can also send a detected gesture with corresponding measurements to a machine learning module 124. The machine learning module 124, which can reside in the storage device 118, may implement machine learning logic to analyze the detected gestures and determine if a previously detected pattern includes intended input. The machine learning module 124 is described in greater detail below in relation to FIG. 3.

In some embodiments, the storage device 120 may also include a sequence module 126 that can detect a series of gestures and perform various tasks such as automatically correcting the spelling of a word, predicting the word that is being entered, or generating a command, among others. The sequence module 126 can also assign a function to any suitable sequence of gestures. For example, the sequence module 126 can detect a sequence of gestures that correspond to modifying the amount of a display device that displays an application, or modifying settings such as audio and video settings, among others. In some embodiments, the sequence module 126 can also detect a sequence of gestures that can be used for authentication purposes. For example, the sequence module 126 may enable access to the computing device 100 in response to detecting a sequence of gestures.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, additional modules, additional network interfaces, etc.). Furthermore, any of the functionalities of the gesture module 120, machine learning module 124, and the sequence module 126 may be partially, or entirely, implemented in hardware and/or in the processor 102. For example, the functionality may be implemented with an application specific integrated circuit, logic implemented in an embedded controller, or in logic or associative memory implemented in the processor 102, among others. In some embodiments, the functionalities of the gesture module 120, machine learning module 124, and the sequence module 126 can be implemented with logic, wherein the logic, as referred to herein, can include any suitable hardware (e.g., a processor, among others), software (e.g., an application, among others), firmware, or any suitable combination of hardware, software, and firmware.

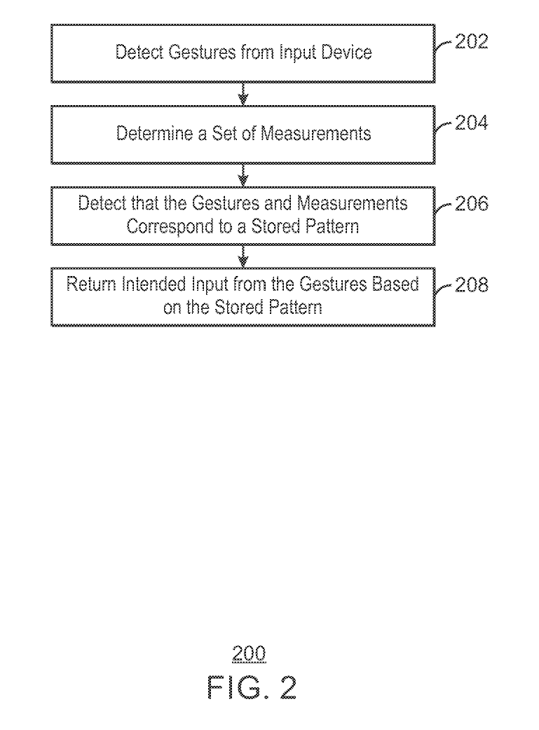

FIG. 2 is a process flow diagram of an example method for detecting erroneous input. The method 200 can be implemented with a computing device, such as the computing device 100 of FIG. 1.

At block 202, the gesture module 120 can detect gestures from an input device. As discussed above, a gesture can include any suitable selection from an input device such as a selection of a key from a keyboard, or a selection of a portion of a touch screen device, among others. In some embodiments, the gesture module 120 can detect any suitable number of gestures simultaneously or within a predefined period of time. For example, a gesture module 120 may detect that any suitable number of gestures entered within a predetermined period of time are to be considered together as a set of gestures.

At block 204, the gesture module 120 can detect a set of measurements that correspond to the detected gestures. In some embodiments, the measurements can include any suitable velocity and/or pressure associated with each gesture. For example, each measurement can correspond to a key selected on a keyboard or a portion of a touch screen device that has been selected, among others. The measurements can indicate the amount of force applied with a gesture. In some examples, the gesture module 120 may use a measurement threshold value to determine if the amount of pressure and/or velocity indicates a selection of a gesture. For example, a key on a keyboard may be pressed lightly so the pressure on the key does not exceed the measurement threshold value. In some examples, any suitable number of gestures may exceed the measurement threshold value and any suitable number of gestures may not exceed the pressure threshold value.

At block 206, the gesture module 120 can detect that the detected gesture and set of measurements correspond to a stored pattern. In some examples, gesture module 120 can compare the detected gesture and set of measurements to previously identified gestures stored in the input storage 122. For example, the gesture module 120 can detect a stored pattern that matches the set of gesture pressures or is within a predetermined range. In some embodiments, the stored pattern may include any suitable number of measurements, such as a pressure and velocity, for any number of inputs included in a gesture. For example, a stored pattern may correspond to a gesture with multiple keystrokes, wherein each keystroke includes a separate velocity and pressure. The stored pattern may also include any number of intended inputs and erroneous inputs. Each stored pattern related to a gesture and corresponding measurements can indicate any suitable number of intend inputs and erroneous inputs. For example, the gesture module 120 may detect multiple keys have been selected on a keyboard, and determine the keys that correspond to intended input and the keys that correspond to erroneous input. In some embodiments, the gesture module 120 detects the intended inputs and erroneous input using machine learning logic described in further detail below in relation to FIG. 3.

At block 208, the gesture module 120 can return an intended input from the gestures based on the stored pattern. In some examples, the gesture module 120 may have previously detected a set of gestures and determined that the set of gestures included erroneous input and intended input. In some examples, a gesture with a greater velocity or pressure may indicate that the gesture was intended. However, a gesture with a slower velocity or pressure may indicate that the gesture was erroneous. In some examples, the erroneous input may have a slower velocity due to a user inadvertently selecting an input while holding a computing device such as a tablet or a mobile device, among others. In one example, the set of gestures may indicate that a keyboard has detected an “a” “q” and “g” selection. The “a” key may not have been selected with enough pressure to exceed a pressure threshold. However, the “q” and “g” keys may have been selected with a pressure that exceeds a pressure threshold. The gesture module 120 may store the pattern of “a” “q” and “g” selections with similar pressure as a “g” and “q” key stroke. In some examples, the gesture module 120 may also determine that selections detected by an input/output device may exceed a measurement threshold, but the selections may be erroneous input. In the previous example, the “q” key may be selected with less pressure than the “g” key, which indicates that the “q” key was an erroneous input. The gesture module 120 may then store “g” as intended input if the “a” “g” and “q” keys are selected but the measurement associated with the “a” key is below a threshold and the measurement associated with the “q” key is smaller than the measurement for the “g” key.

In some examples, the gesture module 120 can also detect erroneous input and intended input from touch screen devices. Furthermore, the gesture module 120 may determine any suitable number of intended inputs and any suitable number of erroneous inputs from a set of gestures.

The process flow diagram of FIG. 2 is not intended to indicate that the operations of the method 200 are to be executed in any particular order, or that all of the operations of the method 200 are to be included in every case. Additionally, the method 200 can include any suitable number of additional operations. For example, the gesture module 120 may also send intended input to a sequence module 128. In some embodiments, the sequence module 126 may detect a series of intended input or gestures and perform various tasks such as automatically correcting the spelling of a word, predicting the word that is being entered, or generating a command, among others. The sequence module 126 can also assign a function to any suitable sequence of gestures. For example, the sequence module 126 can detect a sequence of gestures that correspond to modifying the amount of a display device that displays an application, or modifying user settings such as audio and video settings, among others. In some embodiments, the sequence module 126 can also detect a sequence of gestures that can be used for authentication purposes. For example, the sequence module 126 may enable access to the computing device 100 in response to detecting a sequence of gestures.

FIG. 3 is a process flow diagram of an example method for storing patterns that can detect a gesture. The method 300 can be implemented with any suitable computing device, such as the computing device 100 of FIG. 1.

At block 302, the machine learning module 124 can initialize neurons. In some embodiments, the machine learning module 124 is initialized with example gestures. For example, the machine learning module 124 may receive any suitable number of example gestures and the corresponding erroneous input and intended input. In some examples, the machine learning module 124 may utilize any suitable machine learning technique to detect erroneous input and intended input. In some examples, the machine learning module 124 can load a library as the default initialization of neurons. The machine learning module 124 may then detect the differences between gestures from a user and the library. Alternatively, the machine learning module 124 can also request users to enter gestures and match each gesture with an intended keystroke.

At block 304, the machine learning module 124 can detect gestures. In some embodiments, the machine learning module 124 may receive a single gesture that can include any suitable number of input such as key selections, selections of touch screen devices, and any other suitable input. The machine learning module 124 may also receive a series of gestures that may correspond to a function or a task that is to be performed. In some examples, the series of gestures may correspond to authenticating a user of a computing device, or modifying the settings of computing device, among others.

At block 306, the machine learning module 124 can determine if the detected gesture includes intended input. For example, the machine learning module 116 may detect any suitable number of gestures within stored patterns. In some embodiments, the stored patterns correspond to previously detected gestures that include intended input and erroneous input. In some examples, the machine learning module 124 can detect that the detected gesture is a match for a previously detected gesture based on similar measurements such as pressure and velocity. For example, a number of keystrokes captured as a gesture may correspond to keystrokes in a previously detected gesture. In some embodiments, each previously detected gesture can correspond to a similarity value and the previously detected gesture with a similarity value above a threshold can be returned as a match. The similarity value can include the difference in pressure and/or velocity between the detected gesture and a previously detected gesture. In some examples, the machine learning module 124 can detect intended input by monitoring if a detected gesture is followed by a delete operation. In some embodiments, the machine learning module 124 can store the gesture entered following a delete operation as intended input.

If the machine learning module 124 determines that the detected gesture includes intended input, the process flow continues at block 310. If the machine learning module 124 determines that the detected gesture does not include intended input, the process flow continues at block 308.

At block 308, the machine learning module 124 determines if the detected gesture includes dead space. Dead space, as referred to herein, can include any suitable portion of an input device that receive continuous contact but does not correspond with input. In some examples, the machine learning module 124 can detect that portions of an input device 118 have been selected unintentionally and the portions of the input device 118 include erroneous input. In one example, the dead space may correspond to a user resting a hand on a keyboard or touchscreen device, among others. In some embodiments, the machine learning module 124 can modify the portions of an input device 118 designated as dead space based on the measurements from the dead space. For example, the machine learning module 124 may determine that an area of an input device previously designated as dead space receives a selection with a pressure below a threshold. The machine learning module 124 can then detect input from the area of the input device previously designated as dead space.

If the machine learning module 124 determines that the detected gesture includes dead space, the process flow modifies the gesture module 120 to recognize the dead space at block 312 and the process flow ends at block 314. If the machine learning module 124 determines that the detected gesture does not include dead space, the process flow ends at block 314.

At block 310, the machine learning module 124 can modify stored patterns based on the detected gesture. For example, the machine learning module 124 can determine that a modification of a previously detected gesture has been selected multiple times. In some embodiments, the machine learning module 124 can modify the stored pattern to reflect the modification. For example, a previously detected pattern corresponding to the selection of one or more keystrokes may be modified so that additional keystrokes are included as erroneous input. In some embodiments, the machine learning module 124 can modify the previously detected patterns to reflect a change in the operating environment of a computing device. For example, the machine learning module 124 may detect that additional selections are included in a gesture based on the angle of a computing device or if the computing device is currently in motion. In some embodiments, the machine learning module 124 can detect the operating environment of a computing device based on data received from any suitable number of sensors such as accelerometers, gyrometers, compasses, and GPS devices, among others.

At block 316, the machine learning module 124 can return the intended input. For example, the machine learning module 124 can separate the detected gesture into intended input and erroneous input based on a stored pattern. The machine learning module 124 can also discard the erroneous input and return the intended input. The process flow ends at block 314.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. In some embodiments, the machine learning module 124 can be implemented in associative memory that resides in an input device. For example, any suitable portion of the input device may include associative memory logic that enables the machine learning module 124 to determine if a detected gesture matches previously detected gestures stored as patterns.

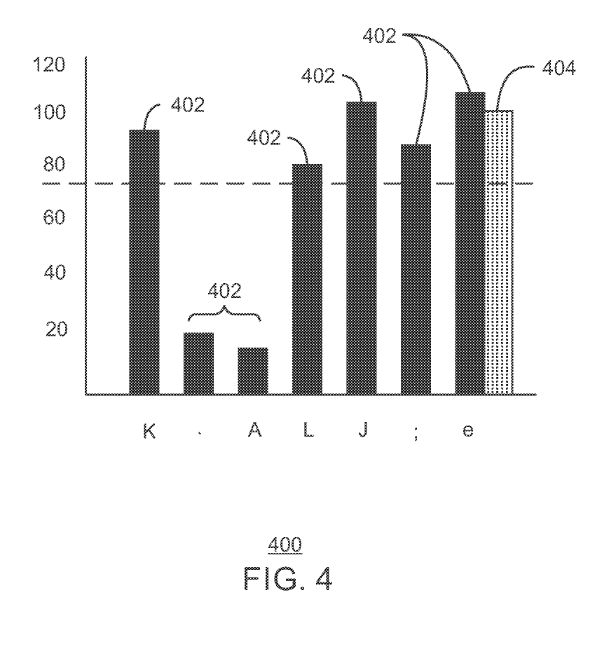

FIG. 4 is an example chart of threshold values that correspond with a gesture. In some embodiments, the gesture can include any suitable number of selections of an input device. For example, the gesture may include any suitable number of keystrokes or selections of a touchscreen device, among others. In some examples, each selection of an input device, also referred to herein as input, can correspond to a measurement such as velocity and pressure, as well as mathematically derived measurements, among others.

The example chart 400 illustrated in FIG. 4 depicts the measurements associated with various keystrokes. Each bar with slanted lines 402 represents the amount of pressure associated with a keystroke in a detected gesture. Each bar with dots 404 represents the velocity at which a keystroke is detected. In this example, the “.” and “a” keystrokes have a pressure and velocity below a threshold. The threshold in the chart of FIG. 4 is a vertical dashed line that represents the amount of pressure that indicates a keystroke is intended input. In some embodiments, the threshold can be any suitable predetermined value. In the example of FIG. 4, the gesture module 120 may determine that the “.” and the “a” keystrokes have been entered erroneously and ignore the keystrokes. In some embodiments, the gesture module 120 may determine that the “.” and “a” keystrokes have a pressure below a threshold for a predetermined period of time that indicates the “.” and “a” keys are to be designated as dead space. As discussed above, dead space can indicate a portion of an input device wherein the gesture module 120 may not attempt to detect intended input. For example, the gesture module 120 may determine that the detected gesture corresponds to an object resting on the “.” and “a” keys while typing.

In some embodiments, the gesture module 120 can detect dead space based on keystrokes with a pressure above a threshold and a velocity below a threshold. For example, the keystrokes “j”, “k”, “I”, and “;” have pressure measurements that exceed a threshold while the velocity measurements are below the threshold. In some embodiments, the gesture module 120 may detect that keystrokes or detected gestures with both pressure and velocity measurements above a threshold include intended input. For example, the “e” keystroke in FIG. 4 includes both a pressure measurement and a velocity measurement above a threshold. The gesture module 120 may determine that the gesture illustrated in FIG. 4 includes an intended input of “e” and dead space of the “j”, “k”, “I”, and “;” portions of a keyboard or touchscreen device. In some examples, the “.” and “a” keystrokes may be designated as noise and ignored.

The chart depicted in FIG. 4 is for illustrative purposes only. The threshold depicted in FIG. 4 can be any suitable value. In addition, a gesture may include any suitable amount of input and the measurements may include pressure and velocity, among others, or any combination thereof.

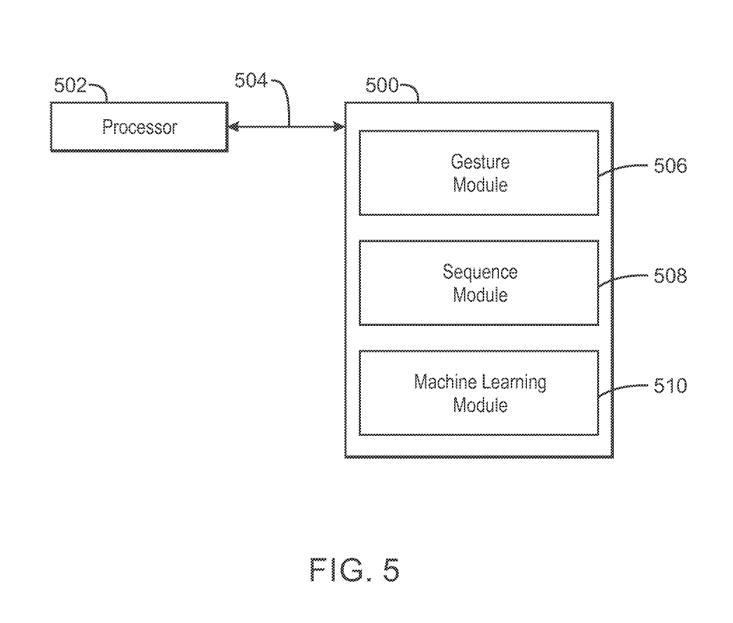

FIG. 5 is a block diagram of an example of a tangible, non-transitory computer-readable medium that can detect a gesture. The tangible, non-transitory, computer-readable medium 500 may be accessed by a processor 502 over a computer interconnect 504. Furthermore, the tangible, non-transitory, computer-readable medium 500 may include code to direct the processor 502 to perform the operations of the current method.

The various software components discussed herein may be stored on the tangible, non-transitory, computer-readable medium 500, as indicated in FIG. 5. For example, a gesture module 506 may be adapted to direct the processor 502 to detect intended input based on a detected gesture and corresponding measurements such as a pressure and velocity. In some embodiments, the gesture module 506 can compare a detected gesture to previously stored patterns to determine the intended input and erroneous input in the gesture. For example, the gesture module 506 may determine that a detected gesture matches a previously detected gesture and that the detected gesture includes intended input and erroneous input. The gesture module 120 may return the intended input and discard or ignore the erroneous input detected in the gesture. In some embodiments, the tangible, non-transitory computer-readable medium 500 may also include a sequence module 508 that can direct the processor 502 to detect a function based on a series of gestures. For example, the sequence module 508 may detect a series of gestures that correspond to modifications to settings of a computing device, or authentication of a computing device, among others. The tangible, non-transitory computer-readable medium 500 may also include a machine learning module 510 that directs the processor 502 to dead space and ignore any input from an area of an input device that corresponds to the dead space.

It is to be understood that any suitable number of the software components shown in FIG. 5 may be included within the tangible, non-transitory computer-readable medium 500. Furthermore, any number of additional software components not shown in FIG. 5 may be included within the tangible, non-transitory, computer-readable medium 500, depending on the specific application.

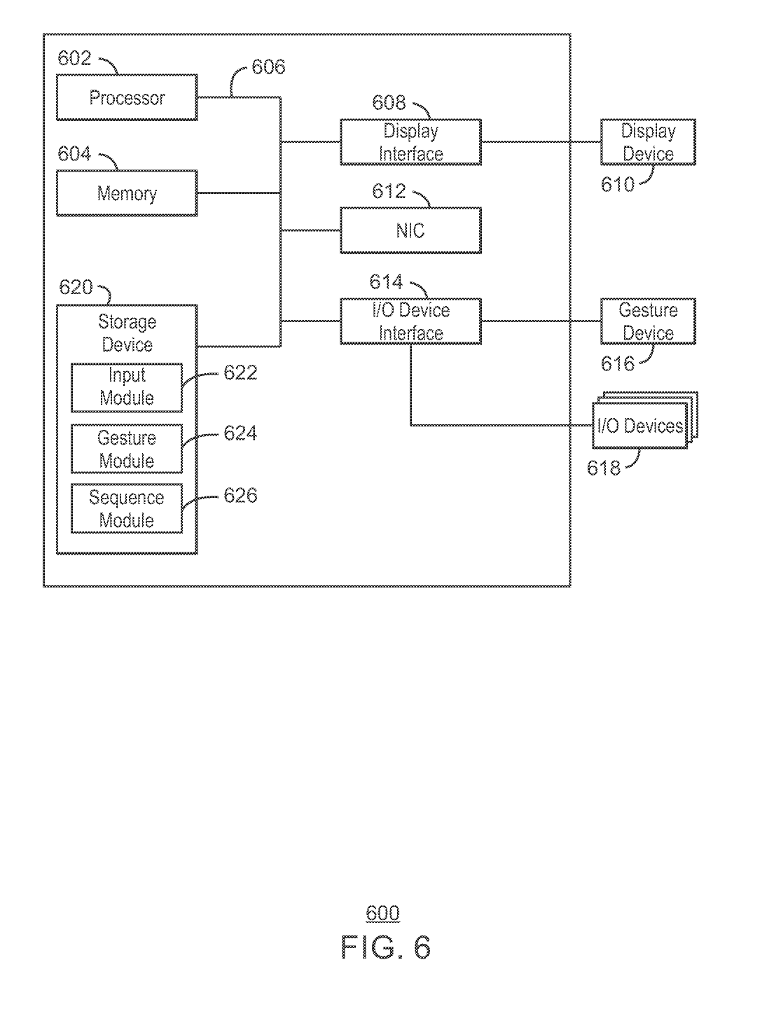

FIG. 6 is a block diagram of an example of a computing device that can detect a gesture from a gesture device. The computing device 600 may be, for example, a mobile phone, laptop computer, desktop computer, or tablet computer, among others. The computing device 600 may include a processor 602 that is adapted to execute stored instructions, as well as a memory device 604 that stores instructions that are executable by the processor 602. The processor 602 can be a single core processor, a multi-core processor, a computing cluster, or any number of other configurations. The memory device 604 can include random access memory, read only memory, flash memory, or any other suitable memory systems. The instructions that are executed by the processor 602 may be used to implement a method that can detect a gesture from a gesture device.

The processor 602 may also be linked through the system interconnect 606 (e.g., PCI®, PCI-Express®, HyperTransport®, NuBus, etc.) to a display interface 608 adapted to connect the computing device 600 to a display device 610. The display device 610 may include a display screen that is a built-in component of the computing device 600. The display device 610 may also include a computer monitor, television, or projector, among others, that is externally connected to the computing device 600. In addition, a network interface controller (also referred to herein as a NIC) 612 may be adapted to connect the computing device 600 through the system interconnect 606 to a network (not depicted). The network (not depicted) may be a cellular network, a radio network, a wide area network (WAN), a local area network (LAN), or the Internet, among others.

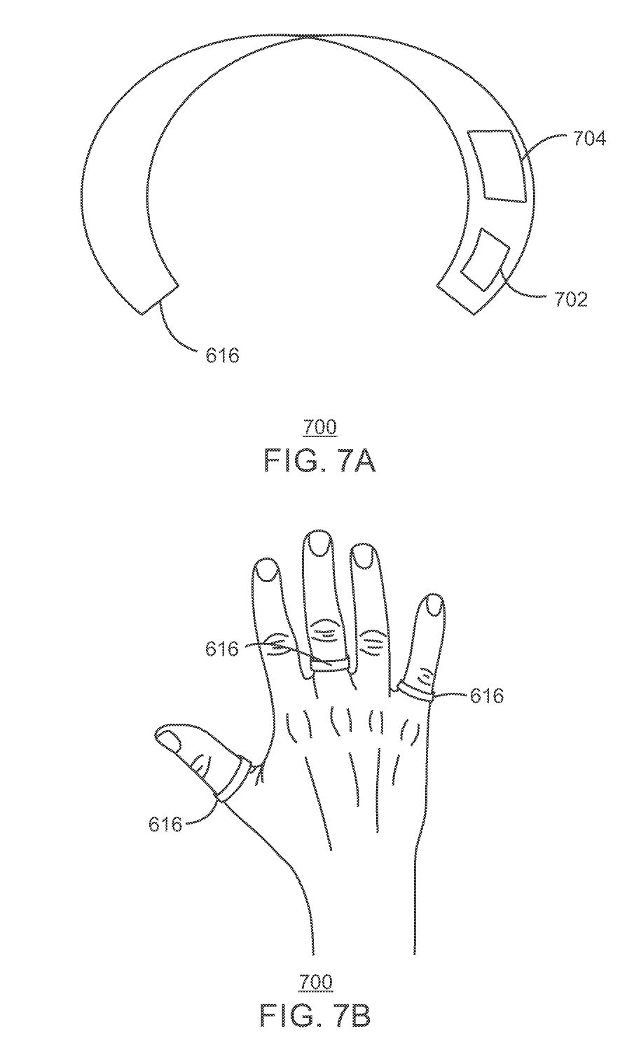

The processor 602 may be connected through a system interconnect 606 to an input/output (I/O) device interface 614 adapted to connect the computing device 600 to one or more gesture devices 616. The gesture device 616, as referred to herein, includes any suitable device that can detect input based on sensor data. For example, a gesture device may include devices with sensors worn around any suitable portion of a user such as fingers, wrists, ankles, and the like. In some embodiments, the gesture device 616 may detect data from any number of sensors that correspond to input. The gesture device 616 may detect data that corresponds to simulated keystrokes, simulated actions related to musical instruments, or simulated actions related to functions, among others. In some embodiments, an I/O device interface 614 may detect data from multiple gesture devices 616. For example, any suitable number of gesture devices 616 may be worn on a user's hand when detecting simulated keystrokes or any other suitable input. The gesture device 616 is described in greater detail below in relation to FIG. 7. In some embodiments, the I/O device interface 614 may also be adapted to connect the computing device 600 to an I/O device 618 such as a keyboard and a pointing device, wherein the pointing device may include a touchpad or a touchscreen, among others. The I/O devices 618 may be built-in components of the computing device 600, or may be devices that are externally connected to the computing device 600.

The processor 602 may also be linked through the system interconnect 606 to a storage device 620 that can include a hard drive, an optical drive, a USB flash drive, an array of drives, or any combinations thereof. In some embodiments, the storage device 620 can include an input module 622. The input module 622 can detect any suitable gesture from the gesture device 616. In some examples, the gesture may include any number of movements or actions associated with input. In some embodiments, the input module 622 can also detect a measurement for each gesture or set of input. As discussed above, a measurement can include the pressure and/or velocity that correspond to a gesture or any other input. In some examples, the measurement may also include the location of a gesture device 616. The input module 622 may use the measurement for each detected gesture or input to determine if a user entered an erroneous keystroke. For example, the gesture device 616r may have moved to a different location or orientation which may cause the data detected by the gesture device 616 to be modified or skewed.

In some embodiments, the storage device 620 can include a gesture module 624 that can detect the input and the measurements from the input module 622. In some embodiments, the gesture module 624 can compare the detected input and the measurements for the detected input with previously detected input stored in input storage 620. In some examples, the storage device 620 may also include input storage 624 that can store previously detected patterns of input and the corresponding erroneous input. For example, the patterns stored in input storage 624 may indicate that the simulated selection of keystrokes may include a subset of erroneously selected keys. In some examples, the subset of erroneously selected keys can result from a user inadvertently selecting keys while entering input on a gesture device 616. For example, the gesture device 616 may detect simulated keystrokes at a modified angle of operation that can result in erroneous input. In some embodiments, the gesture module 624 can compare detected input from a gesture device 616 to previously stored patterns of input to determine if the detected input includes erroneous input. In some embodiments, the gesture module 624 can implement machine learning logic to analyze the detected input and determine if a previously detected pattern includes the intended input. The machine learning logic is described in greater detail above in relation to FIG. 3.

In some embodiments, the storage device 620 may also include a sequence module 626 that can detect a series of gestures and perform various tasks such as automatically correcting the spelling of a word, predicting the word that is being entered, or generating a command, among others. The sequence module 626 can also assign a function to any suitable sequence of gestures. For example, the sequence module 626 can detect a sequence of gestures that correspond to modifying the amount of a display device that displays an application, or modifying user settings such as audio and video settings, among others. In some embodiments, the sequence module 626 can also detect a sequence of gestures that can be used for authentication purposes. For example, the sequence module 626 may enable access to the computing device 600 in response to detecting a sequence of gestures.

It is to be understood that the block diagram of FIG. 6 is not intended to indicate that the computing device 600 is to include all of the components shown in FIG. 6. Rather, the computing device 600 can include fewer or additional components not illustrated in FIG. 6 (e.g., additional memory components, embedded controllers, additional modules, additional network interfaces, etc.). Furthermore, any of the functionalities of the input module 622, the gesture module 624 and the sequence module 626 may be partially, or entirely, implemented in hardware and/or in the processor 602. For example, the functionality may be implemented with an application specific integrated circuit, logic implemented in an embedded controller, in logic implemented in the processor 602, or in logic implemented in the gesture device 616, among others. In some embodiments, the functionalities of the input module 622, the gesture module 624 and the sequence module 626 can be implemented with logic, wherein the logic, as referred to herein, can include any suitable hardware (e.g., a processor, among others), software (e.g., an application, among others), firmware, or any suitable combination of hardware, software, and firmware.

FIG. 7A is a block diagram of an example of a gesture device. The gesture device 616 can include any suitable number of sensors 702 such as an accelerometer, a gyrometer, and the like. In some embodiments, the gesture device 616 can detect sensor data indicating a movement of the gesture device 616 using the sensors 702. The gesture device 616 may also include any suitable wireless interface 704 such as Bluetooth®, or a Bluetooth® compliant interface, among others. In some examples, the gesture device 616 can detect a location of the gesture device 616 in relation to a second gesture device, or any other suitable number of gesture devices, using the wireless interface 704. For example, the gesture device 616 may determine the distance between two gesture devices by transmitting data using the wireless interface 704 and determining the amount of time to transmit the data. The gesture device 616 can also use the wireless interface 704 to send data related to the location of a gesture device 616 and sensor data to an external computing device such as the electronic device 600.

In some embodiments, the gesture device 616 may detect a location and velocity of a gesture, but the gesture device 616 may not detect a pressure corresponding to a gesture. For example, the gesture device 616 may detect a gesture that does not include the gesture device 616 coming into contact with a surface. In some examples, the gesture device 616 may generate a reference point or a reference plane in three dimensional space when detecting a gesture. For example, the gesture device 616 may determine that the gesture device 616 operates at an angle to a plane in three dimensional space and may send the angle to the gesture module 624. In some embodiments, the gesture module 624 may use the angle of operation of a gesture device 616 to determine if a detected gesture matches a previously stored gesture. It is to be understood that the gesture device 616 can include any suitable number of additional modules and hardware components.

FIG. 7B is a diagram illustrating an embodiment with multiple gesture devices. In some examples, a user can wear any suitable number of gesture devices 616 on a user's hand. For example, a user may wear a gesture device 616 on any suitable number of fingers. In some embodiments, as illustrated in FIG. 7B, a user can wear a gesture device 616 on every other finger. The gesture devices 616 may detect input from fingers without a gesture device 616 based on changes in sensor data. For example, moving a finger without a gesture device 616 may result in a proximate finger with a gesture device 616 moving and producing sensor data. In some embodiments, a user may also wear the gesture device 616 as a bracelet. In some examples, a user can wear a gesture device 616 on any number of fingers, and a wrist, or any combination thereof.

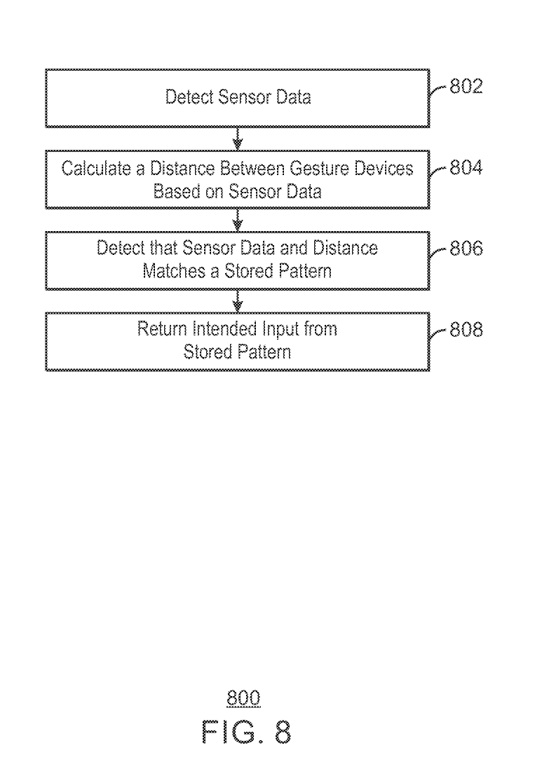

FIG. 8 is a process flow diagram of an example method for detecting gestures from a gesture device. The method 800 can be implemented with any suitable computing device, such as the computing device 600.

At block 802, the input module 622 can detect sensor data from a set of gesture devices. In some embodiments, the gesture devices 616 can include any suitable number of sensors. In some examples, the sensor data can indicate any suitable movement or action. For example, the sensor data can indicate a simulated keystroke, or a simulated selection of a touchscreen device, among others.

At block 804, the gesture module 624 can calculate a distance between each gesture device in the set of gesture devices. In some embodiments, the distance between the gesture devices can be calculated based on an amount of time that elapses during the transmission of data between two gesture devices. For example, the distance may be calculated by determining the amount of time to transmit any suitable amount of data using a protocol, such as Bluetooth®.

At block 806, the gesture module 624 can detect that the detected sensor data and the distance between each gesture device match a previously stored pattern. For example, the gesture module 624 may detect that a gesture that includes input from three gesture devices matches a previously detected gesture based on the location and velocity of the gesture devices. At block 808, the gesture module 624 can return intended input corresponding to the previously stored pattern. For example, the gesture module 624 may detect that the matching pattern includes intended input and erroneous input. The gesture module 624 may ignore the erroneous input and return the intended input as the input selection from the gesture.

The process flow diagram of FIG. 8 is not intended to indicate that the operations of the method 800 are to be executed in any particular order, or that all of the operations of the method 800 are to be included in every case. Additionally, the method 300 can include any suitable number of additional operations.

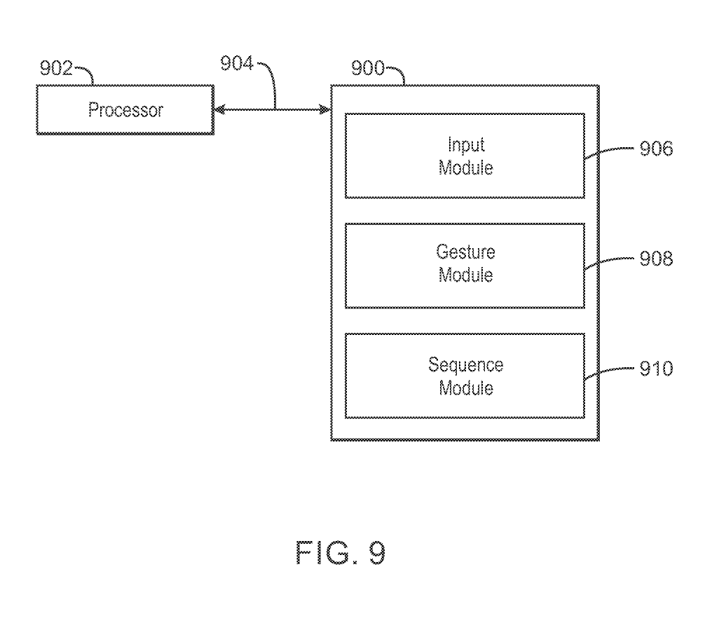

FIG. 9 is a block diagram depicting an example of a tangible, non-transitory computer-readable medium that can detect gestures from a gesture device. The tangible, non-transitory, computer-readable medium 900 may be accessed by a processor 902 over a computer interconnect 904. Furthermore, the tangible, non-transitory, computer-readable medium 900 may include code to direct the processor 902 to perform the operations of the current method.

The various software components discussed herein may be stored on the tangible, non-transitory, computer-readable medium 900, as indicated in FIG. 9. For example, an input module 906 may be adapted to direct the processor 902 to detect sensor data from a gesture device, wherein the sensor data may include a velocity of a gesture device or a location of a gesture device as a gesture is detected. In some embodiments, a gesture module 908 may be adapted to direct the processor 902 to detect intended input based on a detected gesture and sensor data. In some embodiments, the gesture module 908 can compare a detected gesture and sensor data to previously stored patterns to determine the intended input and erroneous input in the gesture. For example, the gesture module 908 may determine that a detected gesture matches a previously detected gesture and that the detected gesture includes intended input and erroneous input. The gesture module 908 may return the intended input and discard or ignore the erroneous input detected in the gesture. In some embodiments, the tangible, non-transitory computer-readable medium 900 may also include a sequence module 910 that can direct the processor 902 to detect a function based on a series of gestures. For example, the sequence module 910 may detect a series of gestures that correspond to modifications to settings of a computing device, or authentication of a computing device, among others.

It is to be understood that any suitable number of the software components shown in FIG. 9 may be included within the tangible, non-transitory computer-readable medium 900. Furthermore, any number of additional software components not shown in FIG. 9 may be included within the tangible, non-transitory, computer-readable medium 900, depending on the specific application.

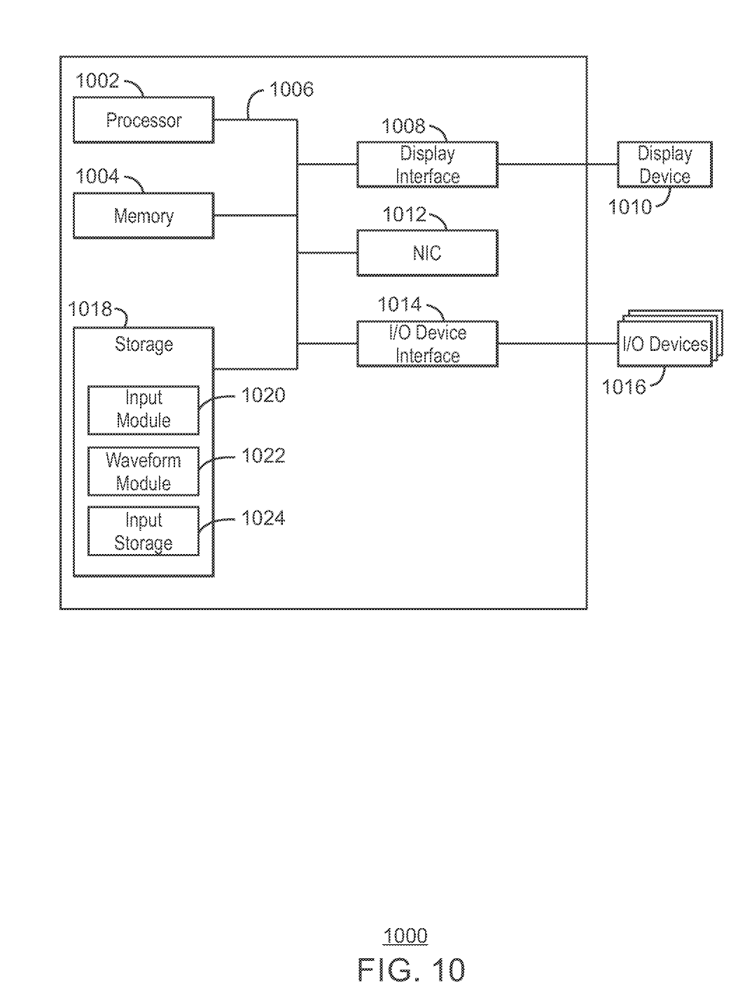

FIG. 10 is a block diagram of an example of a computing system that can detect a waveform. The computing device 1000 may be, for example, a mobile phone, laptop computer, desktop computer, or tablet computer, among others. The computing device 1000 may include a processor 1002 that is adapted to execute stored instructions, as well as a memory device 1004 that stores instructions that are executable by the processor 1002. The processor 1002 can be a single core processor, a multi-core processor, a computing cluster, or any number of other configurations. The memory device 1004 can include random access memory, read only memory, flash memory, or any other suitable memory systems. The instructions that are executed by the processor 1002 may be used to implement a method that can detect a waveform.

The processor 1002 may also be linked through the system interconnect 1006 (e.g., PCI®, PCI-Express®, HyperTransport®, NuBus, etc.) to a display interface 1008 adapted to connect the computing device 1000 to a display device 10100. The display device 10100 may include a display screen that is a built-in component of the computing device 1000. The display device 1010 may also include a computer monitor, television, or projector, among others, that is externally connected to the computing device 1000. In addition, a network interface controller (also referred to herein as a NIC) 1012 may be adapted to connect the computing device 1000 through the system interconnect 1006 to a network (not depicted). The network (not depicted) may be a cellular network, a radio network, a wide area network (WAN), a local area network (LAN), or the Internet, among others.

The processor 1002 may be connected through a system interconnect 1006 to an input/output (I/O) device interface 114 adapted to connect the computing device 1000 to one or more I/O devices 1016. The I/O devices 1016 may include, for example, a keyboard and a pointing device, wherein the pointing device may include a touchpad or a touchscreen, among others. The I/O devices 1016 may be built-in components of the computing device 1000, or may be devices that are externally connected to the computing device 1000.

The processor 1002 may also be linked through the system interconnect 1006 to a storage device 1018 that can include a hard drive, an optical drive, a USB flash drive, an array of drives, or any combinations thereof. In some embodiments, the storage device 1018 can include an input module 1020. The input module 1020 can detect any suitable gesture. For example, the gesture may include any suitable selection of a touchscreen device or a keystroke, among others. In some examples, the input module 1020 can also detect a measurement for each detected gesture. A measurement can include the pressure and/or velocity that correspond to the gesture or any other input. In some examples, the input module 1020 can detect a change in voltage or current detected from any suitable pressure sensitive material in an I/O device 1016 such as resistive films and piezo based materials, among others.

In some embodiments, the storage device 1020 can also include a waveform module 1022 that can detect the input and the measurements from the input module 1018. The waveform module 1022 may also calculate a wave for each gesture or input based on measurements associated with the gesture or input over a period of time. In some embodiments, the waveform module 1022 can compare the detected input and the measurements for the detected input with stored patterns or waveforms in input storage 1024. The stored patterns or waveforms may include previously detected measurements, such as pressure and velocity, for an input over a period of time. In some examples, the storage device 1020 may also include input storage 1024 that can store previously detected patterns that correspond to input. For example, the input storage 1024 may include any suitable number of waveforms for any suitable number of inputs. In some embodiments, the waveform module 1022 can include machine learning logic that can modify the recognized waveforms in input storage 1024. For example, the waveform module 1022 may modify a stored pattern or waveform based on a detected modification to the pressure or velocity associated with an input. The machine learning logic is described in greater detail below in relation to FIG. 3.

It is to be understood that the block diagram of FIG. 10 is not intended to indicate that the computing device 1000 is to include all of the components shown in FIG. 10. Rather, the computing device 1000 can include fewer or additional components not illustrated in FIG. 10 (e.g., additional memory components, embedded controllers, additional modules, additional network interfaces, etc.). Furthermore, any of the functionalities of the input module 1020, and the waveform module 1022 may be partially, or entirely, implemented in hardware and/or in the processor 1002. For example, the functionality may be implemented with an application specific integrated circuit, logic implemented in an embedded controller, logic implemented in an I/O device 1016, or in logic implemented in the processor 1002, among others. In some embodiments, the functionalities of the input module 1020 and the waveform module 1022 can be implemented with logic, wherein the logic, as referred to herein, can include any suitable hardware (e.g., a processor, among others), software (e.g., an application, among others), firmware, or any suitable combination of hardware, software, and firmware.

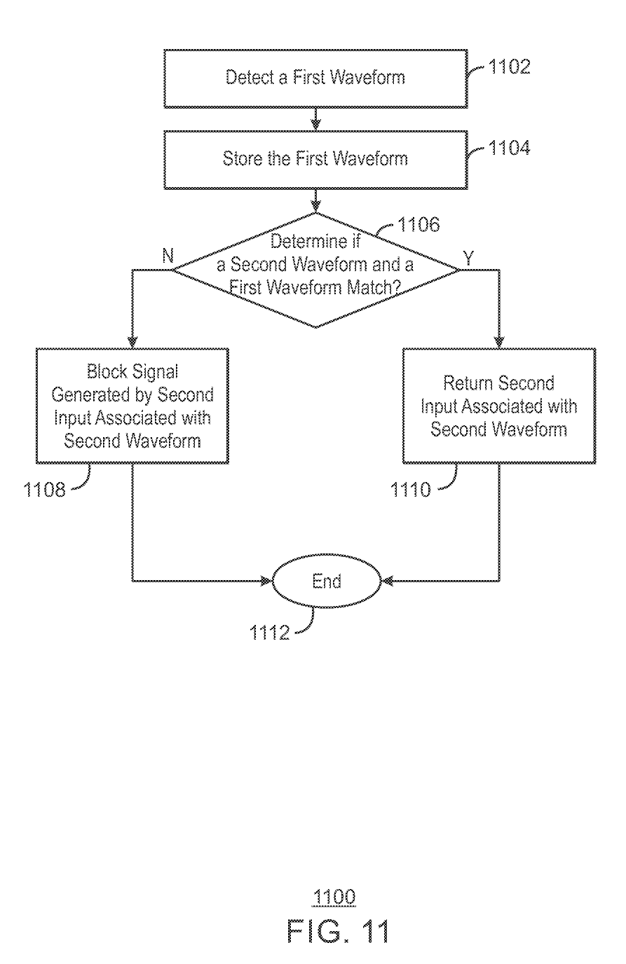

FIG. 11 is a process flow diagram of an example method for detecting a waveform. The method 1100 can be implemented with any suitable computing device, such as the computing device 1000 of FIG. 10.

At block 1102, the waveform module 1022 can detect a first waveform corresponding to a first input. As discussed above, a waveform can include any suitable number of increases and/or decreases in a measurement corresponding with an input. In some examples, the measurement can include a pressure measurement or a velocity measurement. An input can include any suitable selection of a keyboard, touchscreen display, or any other input device. In some examples, a waveform for an input may indicate that a user enters a keystroke or touches a touchscreen display with a similar measurement such as pressure, velocity, or a combination thereof.

At block 1104, the waveform module 1022 can store the first waveform and the corresponding first input as the calibrated input. In some embodiments, the calibrated input can be used to determine if subsequent waveforms associated with subsequent input are to be ignored or the subsequent input is to be returned. In some examples, the waveform module 1022 can store the first waveform detected for an input as calibrated input.

At block 1106, the waveform module 1022 can determine that a second waveform and the first waveform do not match. In some examples, the waveform module 1022 can determine the second waveform and the first waveform do not match by comparing the two waveforms. For example, the waveform module 1022 may compute a value for the first waveform that corresponds to the measurements associated with the first waveform such as the changes in pressure and velocity over a period of time. In some embodiments, the waveform module 1022 can store the computed value for the first waveform and compare values for additional waveforms such as the second waveform to determine a match. If the waveform module 1022 determines that the second waveform and the first waveform match, the process flow continues at block 1110. If the waveform module 1022 determines that the second waveform and the first waveform do not match, the process flow continues at block 1108.

At block 1108, the waveform module 1022 can block a signal generated by the second input. In some examples, the waveform module 1022 blocks the signal generated by the second input to prevent erroneous input. For example, the waveform module 1022 may block the signal for keystrokes or selections of a touchscreen display that do not match previously detected waveforms. In some embodiments, the waveform module 1022 can prevent software, hardware components, firmware, or any combination thereof in the computing device from receiving the signal generated by the second input. The process flow ends at block 1112.

At block 1110, the waveform module 1022 can return the second input if the second waveform and the first waveform match. As discussed above, the second waveform and the waveform can match when the selection of a touchscreen device, a keystroke, or any other suitable input corresponds to measurements that match previous measurements for previous inputs. For example, the waveform module 1022 can return the input if the measurements for the input match the measurements that correspond with previous measurements for the input. In some embodiments, the waveform module 1022 can return keystrokes when the pressure and velocity of each keystroke corresponds to a pressure and velocity of previously detected keystrokes. In some embodiments, the waveform module 1022 can be calibrated for any suitable number of users. Therefore, the waveform module 1022 may store waveforms for each keystroke on a keyboard that correspond to the typing style of a user. The process flow ends at block 1112.

The process flow diagram of FIG. 11 is not intended to indicate that the operations of the method 1100 are to be executed in any particular order, or that all of the operations of the method 1100 are to be included in every case. Additionally, the method 1100 can include any suitable number of additional operations. For example, the waveform module 1022 may also implement machine learning logic that can detect modification to a waveform over time and store the modified waveform.

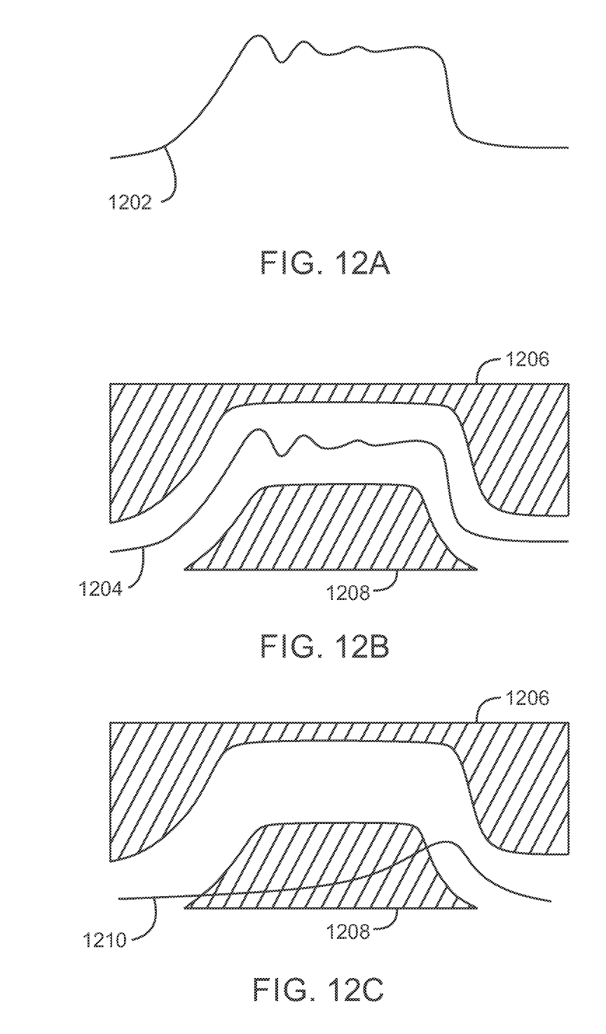

FIGS. 12A, 12B, and 12C are examples of waveforms that correspond to an input. In FIG. 12A, the waveform module 1022 can detect any suitable waveform that corresponds to an input. In some embodiments, the waveform module 1022 may detect a different waveform 1202 for each keystroke or each location on a touchscreen device. As discussed above, the waveform may correspond to a measurement for the input such as a change in pressure or a change in velocity over time. The example illustrated in FIG. 12A includes a waveform 1202 for an input that increases, undulates for a period of time, then decreases.

FIG. 12B illustrates a subsequent waveform that matches the waveform of FIG. 12A. In some embodiments, the waveform module 1022 can determine that the subsequent waveform 1204 matches the previously detected waveform 1202 if the measurements of the subsequent waveform are within a range. For example, the waveform module 1022 may determine that measurements for the subsequent waveform 1204 are within a predetermined range of the previously detected waveform 1202. In some examples, the predetermined range may include a range of pressures, a range of velocities, or any combination thereof. The predetermine range of FIG. 12B is represented by the space between the shaded areas 1206 and 1208.

FIG. 12C illustrates a subsequent waveform that does not match the waveform of FIG. 12A. In the example of FIG. 12C, the subsequent waveform 1210 includes a pressure that does not correspond with a previously detected waveform over time. For example, the subsequent waveform 1210 includes a pressure that is lower than the previously detected waveform 1202 during the first portion of the waveform. In some embodiments, the waveform module 1022 can block the signal generated by the subsequent waveform 1210 so the keystroke corresponding to the subsequent waveform 1210 is not detected by a computing device. It is to be understood that the illustrations of FIGS. 12A, 12B, and 12C are examples and waveforms may include any suitable shape based on any suitable measurement. In some examples, the waveforms may be based on velocities corresponding to input or a combination of pressures and velocities corresponding to an input, among others.

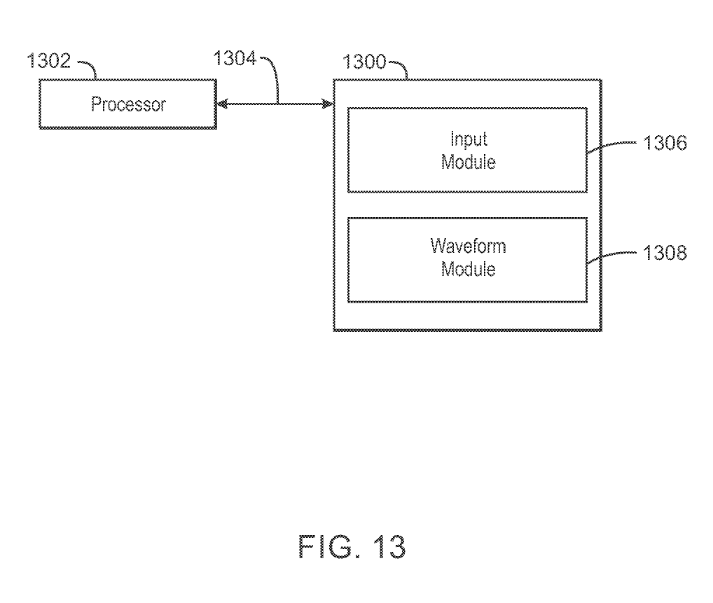

FIG. 13 is a block diagram depicting an example of a tangible, non-transitory computer-readable medium that can detect a waveform. The tangible, non-transitory, computer-readable medium 1300 may be accessed by a processor 1302 over a computer interconnect 1304. Furthermore, the tangible, non-transitory, computer-readable medium 1300 may include code to direct the processor 1302 to perform the operations of the current method.

The various software components discussed herein may be stored on the tangible, non-transitory, computer-readable medium 1300, as indicated in FIG. 13. For example, an input module 1306 may be adapted to direct the processor 1302 to detect measurements, such as pressure and velocity, for input. In some examples, the input can include any keystroke or selection of a touch screen display. The measurements may be monitored over any suitable period of time to generate a waveform. A waveform module 1308 may be adapted to direct the processor 1302 to detect a first waveform corresponding to a first input and store the first waveform and the corresponding first input as the calibrated input. The waveform module 1308 may also be adapted to direct the processor 1302 to compare a second waveform corresponding to a second input to the first waveform and determine that the second waveform and the first waveform do not match. The waveform module 1308 may also direct the processor 1302 to block a signal generated by the second keystroke.

It is to be understood that any suitable number of the software components shown in FIG. 13 may be included within the tangible, non-transitory computer-readable medium 1300. Furthermore, any number of additional software components not shown in FIG. 13 may be included within the tangible, non-transitory, computer-readable medium 1300, depending on the specific application.

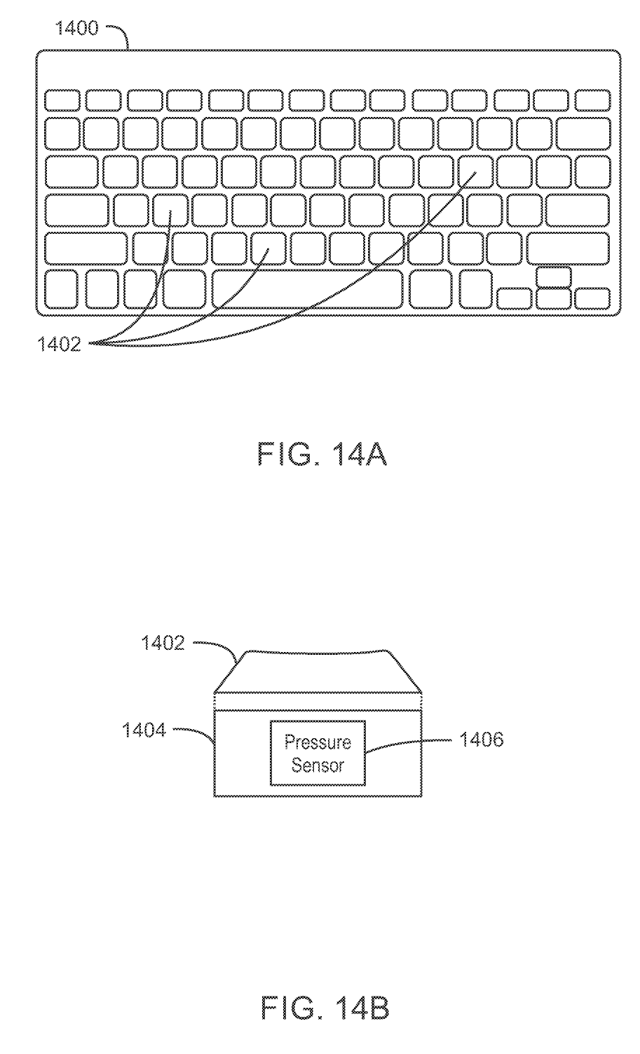

FIG. 14A is a block diagram of an example input device that can detect input and/or gestures. In some examples, the input device 1400 can be any suitable keyboard that can detect input or gestures. For example, the input device 1400 may be a keyboard with any suitable number of input areas (also referred to herein as keys) 1402 that detect keystrokes. In some embodiments, the input device 1400 can also detect non-keystroke gestures. For example, the input device 1400 may detect a user swiping the input device 1400 from one side to the opposite side which indicates a function. In some examples, a function may include modifying an audio level, among others. In some embodiments, the input device 1400 can detect a non-keystroke gesture based on the selection of any suitable number or combination of keys 1402.

FIG. 14B is a block diagram of an example key of the input device that can detect input and/or gestures. In some embodiments, each key 1402 can include a pressure sensitive material 1404 and a pressure sensor 1406. The pressure sensitive material 1404 can enable the pressure sensor 1406 to determine the pressure and/or velocity at which a key 1402 is selected. In some embodiments, the pressure sensor 1406 can transmit detected pressure and/or velocity data to any suitable hardware component or application such as the gesture module 120 of FIG. 1 or the input module 1020 of FIG. 10, among others.

### Example 1

A method for analyzing gestures is described herein. In some examples, the method can include detecting the gestures from an input device and detecting a set of measurements, wherein each measurement corresponds to a gesture. The method can also include detecting that the set of measurements and the gestures correspond to a stored pattern and returning intended input from the gestures based on the stored pattern.

In some embodiments, wherein the set of gestures comprises a set of selected keys from a keyboard or a touch screen device. In some examples, the stored pattern comprises previously detected erroneous input and previously detected intended inputs. The method can also include detecting a velocity corresponding to each gesture, and detecting a pressure corresponding to each gesture. Additionally, the method can include detecting a set of previously detected patterns, and detecting the stored pattern with a similarity value above a threshold from the set of previously detected patterns. In some embodiments, the method includes detecting dead space that corresponds to an input device. The method can also include detecting a sequence of gestures, and executing a function based on the sequence of gestures.

### Example 2

An electronic device for analyzing gestures is also described herein. In some embodiments, the electronic device includes logic to detect the gestures from an input device and detect a set of measurements, wherein each measurement corresponds to a gesture. The logic can also detect that the set of measurements and the gestures correspond to a stored pattern and return intended input from the gestures based on the stored pattern.

In some embodiments, the logic can detect a set of previously detected patterns, and detect the stored pattern with a similarity value above a threshold from the set of previously detected patterns. In some embodiments, the logic can also detect dead space that corresponds to an input device. The logic can also detect a sequence of gestures, and execute a function based on the sequence of gestures.

### Example 3

At least one non-transitory machine readable medium having instructions stored therein that analyze gestures are described herein. The at least one non-transitory machine readable medium can have instructions that, in response to being executed on an electronic device, cause the electronic device to detect the gestures from an input device and detect a set of measurements, wherein each measurement corresponds to a gesture. The instructions can also cause the electronic device to detect that the set of measurements and the gestures correspond to a stored pattern and return intended input from the gestures based on the stored pattern. In some embodiments, the set of gestures comprises a set of selected keys from a keyboard or a touch screen device. In some examples, the stored pattern comprises previously detected erroneous input and previously detected intended inputs.

### Example 4

A method for detecting a gesture is described herein. In some examples, the method includes detecting sensor data from a set of gesture devices and calculating a distance between each gesture device in the set of gesture devices. The method also includes determining that the detected sensor data and the distance between each gesture device match a previously stored pattern, and returning an input corresponding to the previously stored pattern.

In some embodiments, the distance is based on a data transmission time. In some examples, the method can include calculating the data transmission time based on a protocol to transmit the data, wherein the protocol is Bluetooth® compliant. In some embodiments, the input comprises a selection from a keyboard or a touchscreen display device.

### Example 5

An electronic device for detecting a gesture is described herein. In some examples, the electronic device includes logic that can detect sensor data from a set of gesture devices and calculate a distance between each gesture device in the set of gesture devices. The logic can also determine that the detected sensor data and the distance between each gesture device match a previously stored pattern, and return an input corresponding to the previously stored pattern. In some embodiments, the distance is based on a data transmission time. In some examples, the logic can include calculating the data transmission time based on a protocol to transmit the data, wherein the protocol is Bluetooth® compliant. In some embodiments, the input comprises a selection from a keyboard or a touchscreen display device.

### Example 6

At least one non-transitory machine readable medium having instructions stored therein that can detect a gesture is described herein. The at least one non-transitory machine readable medium having instructions that, in response to being executed on an electronic device, cause the electronic device to detect sensor data from a set of gesture devices and calculate a distance between each gesture device in the set of gesture devices. The instructions can also cause the electronic device to determine that the detected sensor data and the distance between each gesture device match a previously stored pattern and return an input corresponding to the previously stored pattern. In some embodiments, the distance is based on a data transmission time. In some examples, the logic can include calculating the data transmission time based on a protocol to transmit the data. In some embodiments, the input comprises a selection from a keyboard or a touchscreen display device.

### Example 7

An electronic device for detecting input is also described herein. The electronic device can include logic to detect sensor data indicating a movement of the electronic device and detect a location of the electronic device in relation to a second electronic device. The logic can also send the location and the sensor data to an external computing device. In some embodiments, the electronic device comprises a sensor that detects the sensor data. In some examples, the sensor is an accelerometer or a gyrometer.

### Example 8

A method for detecting a calibrated input is described herein. The method can include detecting a first waveform corresponding to a first input and storing the first waveform and the corresponding first input as the calibrated input. The method can also include comparing a second waveform corresponding to a second input to the first waveform of the calibrated input and determining that the second waveform and the first waveform do not match. Additionally, the method can include blocking a signal generated by the second input.

In some embodiments, the first waveform is based on a change in a voltage corresponding to the first input, wherein the change in the voltage indicates a pressure and a velocity corresponding to the first input. In some examples, the method also includes determining that a third waveform corresponding to a third input matches the first waveform corresponding to the calibrated input, and returning the third input. Additionally, the method can include comparing the pressure and the velocity corresponding to the first input to a pressure and a velocity corresponding to the second input, and determining that a difference between the pressure and the velocity of the first input and the pressure and the velocity of the second input exceeds a threshold value.

### Example 9

An electronic device for detecting a calibrated input is described herein. In some examples, the electronic device includes logic that can detect a first waveform corresponding to a first input and compare a second waveform corresponding to a second input to the first waveform. The logic can also determine that the second waveform and the first waveform do not match, and block a signal generated by the second input.

In some embodiments, the first waveform is based on a change in a voltage corresponding to the first input, wherein the change in the voltage indicates a pressure and a velocity corresponding to the first input. In some examples, the logic can also determine that a third waveform corresponding to a third input matches the first waveform corresponding to the calibrated input, and return the third input. Additionally, the logic can compare the pressure and the velocity corresponding to the first input to a pressure and a velocity corresponding to the second input, and determine that a difference between the pressure and the velocity of the first input and the pressure and the velocity of the second input exceeds a threshold value.

### Example 10

At least one non-transitory machine readable medium having instructions stored therein that can detect calibrated input is described herein. The at least one non-transitory machine readable medium can have instructions that, in response to being executed on an electronic device, cause the electronic device to detect a first waveform corresponding to a first input and compare a second waveform corresponding to a second input to the first waveform. The at least one non-transitory machine readable medium can also have instructions that, in response to being executed on an electronic device, cause the electronic device to determine that the second waveform and the first waveform do not match, and block a signal generated by the second input. In some embodiments, the first waveform is based on a change in a voltage corresponding to the first input, wherein the change in the voltage indicates a pressure and a velocity corresponding to the first input. In some examples, the instructions can cause an electronic device to determine that a third waveform corresponding to a third input matches the first waveform corresponding to the calibrated input, and return the third input.

Although an example embodiment of the disclosed subject matter is described with reference to block and flow diagrams in FIGS. 1-14, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for analyzing gestures comprising:
detecting the gestures from an input device;
detecting a set of measurements, wherein each measurement corresponds to a gesture;
detecting that the set of measurements and the gestures correspond to a stored pattern; and
returning intended input from the gestures based on the stored pattern.

2. The method of claim 1, wherein the set of gestures comprises a set of selected keys from a keyboard.

3. The method of claim 1, wherein the set of gestures comprises a set of selections from a touch screen device.

4. The method of claim 1, wherein the stored pattern comprises previously detected erroneous input and previously detected intended inputs.

5. The method of claim 1, wherein detecting the set of measurements comprises:
detecting a velocity corresponding to each gesture; and
detecting a pressure corresponding to each gesture.

6. The method of claim 1, wherein detecting that the set of measurements and the gestures correspond to the stored pattern comprises:
detecting a set of previously detected patterns; and
detecting the stored pattern with a similarity value above a threshold from the set of previously detected patterns.

7. The method of claim 1, comprising detecting dead space that corresponds to an input device.

8. The method of claim 1, comprising:
detecting a sequence of gestures; and
executing a function based on the sequence of gestures.

9. An electronic device for analyzing gestures comprising:
logic to:
detect the gestures from an input device;
detect a set of measurements, wherein each measurement corresponds to a gesture;
detect that the set of measurements and the gestures correspond to a stored pattern;
return intended input from the gestures based on the stored pattern.

10. The electronic device of claim 9, wherein the set of gestures comprises a set of selected keys from a keyboard.

11. The electronic device of claim 9, wherein the set of gestures comprises a set of selections from a touch screen device.

12. The electronic device of claim 9, wherein the stored pattern comprises previously detected erroneous input and previously detected intended inputs.

13. The electronic device of claim 9, wherein the logic is to:
detect a velocity corresponding to each gesture; and
detect a pressure corresponding to each gesture.

14. The electronic device of claim 9, wherein the logic is to:
detect a set of previously detected patterns; and
detect the stored pattern with a similarity value above a threshold from the set of previously detected patterns.

15. The electronic device of claim 9, wherein the logic is to detect an erroneous input from the gestures; and
return the intended input from the stored pattern.

16. The electronic device of claim 9, wherein the logic is to:
detect a sequence of gestures; and
execute a function based on the sequence of gestures.

17. At least one non-transitory machine readable medium having instructions stored therein that, in response to being executed on an electronic device, cause the electronic device to:
detect the gestures from an input device;
detect a set of measurements, wherein each measurement corresponds to a gesture;
detect that the set of measurements and the gestures correspond to a stored pattern; and
return intended input from the gestures based on the stored pattern.

18. The at least one non-transitory machine readable medium of claim 17, wherein the set of gestures comprises a set of selected keys from a keyboard.

19. The at least one non-transitory machine readable medium of claim 17, wherein the set of gestures comprises a set of selections from a touch screen device.

20. The at least one non-transitory machine readable medium of claim 17, wherein the stored pattern comprises previously detected erroneous input and previously detected intended inputs.

21. The at least one non-transitory machine readable medium of claim 17, wherein the instructions, in response to being executed on an electronic device, cause the electronic device to:
detect a velocity corresponding to each gesture; and
detect a pressure corresponding to each gesture.

22. The at least one non-transitory machine readable medium of claim 17, wherein the instructions, in response to being executed on an electronic device, cause the electronic device to:
detect an erroneous input and the intended input from the gestures; and
return the intended input from the stored pattern.

23. The at least one non-transitory machine readable medium of claim 17, wherein the instructions, in response to being executed on an electronic device, cause the electronic device to:
detect a sequence of gestures; and
execute a function based on the sequence of gestures.

24. A method for detecting a gesture comprising:
detecting sensor data from a set of gesture devices;
calculating a distance between each gesture device in the set of gesture devices;
determining that the detected sensor data and the distance between each gesture device match a previously stored pattern; and
returning an input corresponding to the previously stored pattern.

25. The method of claim 24, wherein, the distance is based on a data transmission time.

26. The method of claim 25, comprising calculating the data transmission time based on a protocol to transmit the data.

27. The method of claim 26, wherein the protocol is Bluetooth® compliant.

28. The method of claim 24, wherein the input comprises a selection from a keyboard.

29. The method of claim 24, wherein the input comprises a selection from a touchscreen display device.

30. An electronic device for detecting a gesture, comprising:
logic to:
detect sensor data from a set of gesture devices;
calculate a distance between each gesture device in the set of gesture devices;
determine that the detected sensor data and the distance between each gesture device match a previously stored pattern; and
return an input corresponding to the previously stored pattern.

31. The electronic device of claim 30, wherein, the distance is based on a data transmission time.

32. The electronic device of claim 31, wherein the logic is to calculate the data transmission time based on a protocol to transmit the data.

33. The electronic device of claim 32, wherein the protocol is Bluetooth® compliant.

34. The electronic device of claim 30, wherein the input comprises a selection from a keyboard.

35. The electronic device of claim 30, wherein the input comprises a selection from a touchscreen display device.

36. At least one non-transitory machine readable medium having instructions stored therein that, in response to being executed on an electronic device, cause the electronic device to:
detect sensor data from a set of gesture devices;
calculate a distance between each gesture device in the set of gesture devices;
determine that the detected sensor data and the distance between each gesture device match a previously stored pattern; and
return an input corresponding to the previously stored pattern.

37. The at least one non-transitory machine readable medium electronic device of claim 36, wherein the distance is based on a data transmission time.

38. The at least one non-transitory machine readable medium of claim 37, wherein the instructions, in response to being executed on the electronic device, cause the electronic device to calculate the data transmission time based on a protocol to transmit the data.

39. The at least one non-transitory machine readable medium of claim 36 wherein the input comprises a selection from a keyboard.

40. The at least one non-transitory machine readable medium of claim 36, wherein the input comprises a selection from a touchscreen display device.

41. An electronic device for detecting input, comprising:
logic to:
detect sensor data indicating a movement of the electronic device;
detect a location of the electronic device in relation to a second electronic device; and
send the location and the sensor data to an external computing device.

42. The electronic device of claim 41, wherein the electronic device comprises a sensor that detects the sensor data.

43. The electronic device of claim 42, wherein the sensor is an accelerometer or a gyrometer.

44. A method for detecting a calibrated input comprising:
detecting a first waveform corresponding to a first input;
storing the first waveform and the corresponding first input as the calibrated input;
comparing a second waveform corresponding to a second input to the first waveform of the calibrated input;
determining that the second waveform and the first waveform do not match; and
blocking a signal generated by the second input.

45. The method of claim 44, wherein the first waveform is based on a change in a voltage corresponding to the first input.

46. The method of claim 45, wherein the change in the voltage indicates a pressure and a velocity corresponding to the first input.

47. The method of claim 44 comprising:
determining that a third waveform corresponding to a third input matches the first waveform corresponding to the calibrated input; and
returning the third input.

48. The method of claim 47, wherein determining that the second waveform and the first waveform do not match comprises:
comparing the pressure and the velocity corresponding to the first input to a pressure and a velocity corresponding to the second input; and
determining that a difference between the pressure and the velocity of the first input and the pressure and the velocity of the second input exceeds a threshold value.

49. An electronic device for detecting a calibrated input comprising:
logic to:
detect a first waveform corresponding to a first input;
compare a second waveform corresponding to a second input to the first waveform;
determine that the second waveform and the first waveform do not match; and
block a signal generated by the second input.

50. The electronic device of claim 49, wherein the first waveform is based on a change in a voltage corresponding to the first input.

51. The electronic device of claim 50, wherein the change in the voltage indicates a pressure and a velocity corresponding to the first input.

52. The electronic device of claim 49, wherein the logic is to:
determine that a third waveform corresponding to a third input matches the first waveform; and
return the third input.

53. The electronic device of claim 52, wherein the logic is to:
compare the pressure and the velocity corresponding to the first input to a pressure and a velocity corresponding to the second input; and
determine that a difference between the pressure and the velocity of the first input and the pressure and the velocity of the second input exceeds a threshold value.

54. At least one non-transitory machine readable medium having instructions stored therein that, in response to being executed on an electronic device, cause the electronic device to:
detect a first waveform corresponding to a first input;
compare a second waveform corresponding to a second input to the first waveform;
determine that the second waveform and the first waveform do not match; and
block a signal generated by the second input.

55. The at least one non-transitory machine readable medium of claim 54, wherein the first waveform is based on a change in a voltage corresponding to the first input.

56. The at least one non-transitory machine readable medium of claim 55, wherein the change in the voltage indicates a pressure and a velocity corresponding to the first input.

57. The at least one non-transitory machine readable medium of claim 54, wherein the instructions, in response to being executed on the electronic device, cause the electronic device to:
determine that a third waveform corresponding to a third input matches the first waveform; and
return the third input.

58. The at least one non-transitory machine readable medium of claim 57, wherein the instructions, in response to being executed on the electronic device, cause the electronic device to:
compare the pressure and the velocity corresponding to the first input to a pressure and a velocity corresponding to the second input; and
determine that a difference between the pressure and the velocity of the first input and the pressure and the velocity of the second input exceeds a threshold value.
